(19) United States
(12) Patent Application Publication
(10) Pub. No.: US 2007/0024056 A1
(43) Pub. Date: Feb. 1, 2007

(54) Conduit coupling

(76) Inventor: Robin Neil Borland, Smethport, PA (US)

Correspondence Address: FISH & RICHARDSON P.C., P.O. BOX 1022, MINNEAPOLIS, MN, 55440-1022, US

(21) Appl. No.: 11/543,662

(22) Filed: Oct. 5, 2006

Related U.S. Application Data
(63) Continuation-in-part of application No. 10/965,310, filed on Oct. 14, 2004.
(60) Provisional application No. 60/511,614, filed on Oct. 15, 2003.

(51) Int. Cl. F16L 21/02

(52) U.S. Cl. 285/369

(57) ABSTRACT

A conduit coupler and method of coupling conduits includes a link member; a circumferential, flexible sealing element,; and a constricting element. The constricting element surrounds at least a majority of the outer radius of the sealing element and adapted to slidably engage the sealing element and the outer surface of link member. The constricting element and the link member compress the sealing element radially and axially as the constricting element constricts. The constricting element comprises at least two section members, each section member coupled to at least one other section member by engagement between a male fitting on one of the coupled members and a female fitting on the other of the coupled members.

### RELATED APPLICATIONS

This application is a continuation-in-part of U.S. patent application Ser. No. 10/965,310, filed on Oct. 14, 2004, which claims the benefit of U.S. Provisional Patent Application No. 60/511,614, filed on Oct. 15, 2003.

### TECHNICAL FIELD

This invention relates to fluid flow and, more particularly, to fluid flow through conduits.

### BACKGROUND

There are many underground pipelines for water, gas, and sewer systems. The type and size of pipe used for each pipeline system may depend on the age of the system. For example, an older system may use cast-iron pipe of a certain size, a more recent system may use asbestos-cement pipe of another size, and a newly-installed system may use PVC or ductile-iron pipe of yet another size. In certain systems, there is even a mixture of components of various materials, sizes, and ages.

It will be understood by those skilled in the art that even pipes of the same nominal size may have differing outside diameters (“ODs”) based on composition and/or pressure rating. For example, pipes of the same nominal size and composition may have different ODs for different pressure ratings, due to a difference in wall thickness. Additionally, pipes of the same nominal size manufactured from different materials may have different ODs. For instance, if a pipe has a nominal size of 6.0 inches, it could have an OD of 6.90 inches if it is made of cast iron or ductile iron, 6.625 inches OD if it is made of steel, and 7.60 inches if it is made of asbestos cement. Thus, trying to couple nominal 6.0-inch pipes could lead to having to accommodate pipes with an outer diameter range of 1.1 inches.

It is common practice when a pipeline system is damaged to cut out the damaged section of pipe and install a new piece of pipe using two couplings, one for each end of the removed section. The replacement pipe, however, may not be of the same nominal size, composition, and/or outer diameter as the existing pipe.

One type of device for repairing a damaged pipeline is a pipe coupling. For one type of pipe coupling, a seal may be made by a follower squeezing a wedge-shaped gasket against the pipe to be sealed and a middle ring when actuated by circumferentially-arranged trackhead bolts. Another type of pipe coupling is shown in U.S. Pat. No. 5,941,576. This pipe clamp includes a sleeve (1) with an oblique outwardly flaring end flange (2) and a bolt-driven, circumferential clamping ring (5) that bear on a seal (4).

### SUMMARY

Conduit coupling may couple two conduit members end-to-end such that a fluid-tight passageway is provided between the members. Conduit coupling may be used to couple isolated conduits or conduits that are part of a larger conduit system.

In one general aspect, a conduit coupler may include a link member, a circumferential, flexible sealing element, and a constricting element. The link member may include a first portion and a second portion, the first portion adapted to span the region between two conduits to be coupled, the second portion coupled to the first portion and including an inner surface and an outer surface. The sealing element may be adapted to slidably engage the inner surface of the second portion of the link member. In particular implementations, the sealing element may be a unitary, polymeric gasket. The constricting element may surround at least a majority of the outer radius of the sealing element and be adapted to slidably engage the sealing element and the outer surface of the second portion of the link member. The constricting element and the inner surface of the second portion of the link member may compress the sealing element radially and axially as the constricting element constricts.

The link member, the sealing element, and the constricting element may be adapted to form a seal over a range of conduit outer dimensions. For example, the range may be greater than one inch for conduits having a nominal size of six inches.

In certain implementations, the first portion of the link member is a cylindrical sleeve, and the second portion of the link member is an outwardly-flaring, circumferential flange. The sealing element may include a pressure-assist cavity that opens toward the first portion of the link member.

The constricting element may be a curved element with a V-shaped cross-section. A first leg of the curved element may slidably engage the outer surface of the second portion of the link member, and a second leg of the curved element may slidably engage the sealing element such that the sealing element is axially forced toward the second portion of the link member by the second leg as the constricting element constricts. At least one of the first leg and the second leg may include a plurality of radially-disposed slots. The constricting element may be adapted to engage a conduit to be coupled to deter axial movement of the conduit coupler.

The constricting element may include a first section, a second section, and a coupling system coupled to the first section and the second section. The coupling system may movably couple the first section and the second section. The coupling system may, for example, include a hinge mechanism.

Certain implementations may include a fastening system coupled to the constricting element, the fastening system operable to constrict and relax the constricting element. The fastening system may include a first lug, a second lug, a bolt, and a nut. The first lug may be coupled to a first end of the constricting element, and the second lug may be coupled to a second end of the constricting element. The bolt may span the distance between the first lug and the second lug, and the nut may be tightenable on the bolt to draw the first lug and the second lug toward each other, the constricting element being constricted as the lugs are drawn toward each other.

In another general aspect, a process for coupling conduits may include positioning a sealing system around a first conduit, the sealing system including a circumferential, flexible sealing element and a constricting element, the constricting element surrounding at least a majority of the outer radius of the sealing element and adapted to slidably engage the sealing element, the constricting element causing the sealing element to be compressed radially and axially as the constricting element constricts. The process also may include positioning a link member around the first conduit and a second conduit, the link member including a first portion and a second portion, the first portion adapted to span the region between the two conduits, the second portion coupled to the first portion and including an inner surface and an outer surface, the inner surface adapted to slidably engage the sealing element and to radially and axially compress the sealing element, the outer surface adapted to slidably engage the constricting element. The process further may include constricting the constricting element until the sealing element engages the first conduit.

The sealing element may include a pressure-assist cavity that opens toward the first portion of the link member. The constricting element may include a curved element with a V-shaped cross-section, a first leg of the curved element slidably engaging the outer surface of the second portion of the link member, a second leg of the curved element slidably engaging the sealing element, the sealing element being axially forced toward the second portion of the link member by the second leg as the constricting element constricts. At least one of the first leg and the second leg may include a plurality of radially-disposed slots. The constricting element may include a first section, a second section, and a coupling system coupled to the first section and the second section. The coupling system may movably couple the first section and the second section. The sealing element and the constricting element may be adapted to form a seal over a range of conduit outer dimensions.

In certain implementations, constricting the constricting element until the sealing element engages the first conduit may include manipulating a fastening system coupled to the constricting element, the fastening system operable to constrict and relax the constricting element. Constricting the constricting element until the sealing element engages the first conduit also may include constricting the constricting element until the constricting element engages the first conduit.

In yet another general aspect, a conduit coupler includes a link member and two sealing elements. The link member includes a cylindrical middle sleeve and two open-end portions, each end portion including an outwardly-flaring, circumferential flange having an inner surface and an outer surface. The first sealing system is coupled to one of the flanges, and the second sealing system is coupled to the other of the flanges. Each sealing system includes a circumferential, flexible sealing element, a constricting element, a spanner, and a fastening system. The sealing element slidably engages the inner surface of the associated flange and includes a unitary, polymeric gasket and a pressure-assist cavity that opens toward the sleeve of the link member. The constricting element includes a V-shaped cross-section curved element of unitary construction, a first leg of the constricting element slidably engaging the outer surface of the associated flange, a second leg of the constricting element slidably engaging the sealing element, the second leg including a plurality of radially-disposed slots. The constricting element defines an outer boundary of an inner cavity for a majority of the sealing element and, in conjunction with the inner surface of the associated flange, compresses the sealing element radially and axially as the constricting element constricts, the sealing element being axially forced toward the inner surface of the associated flange as the constricting element constricts. The constricting element is adapted to engage an outer surface of a conduit on which the conduit coupler is to be installed to deter axial movement of the conduit coupler. The spanner includes a V-shaped cross-section curved element of unitary construction, a first leg of the spanner slidably engaging the outer surface of the associated flange and the first leg of the constricting element, a second leg of the spanner slidably engaging the sealing element and the second leg of constricting curved element. The spanner defines an outer boundary of an inner cavity for a portion of the sealing element and, in conjunction with the inner surface of the associated flange, compresses the sealing element radially and axially as the constricting element constricts, the sealing element being axially forced toward the inner surface of the associated flange as the constricting element constricts. The fastening system is coupled to the constricting element and is operable to constrict and relax the constricting element. The fastening system includes a first lug coupled to a first end of the constricting element, a second lug coupled to a second end of the constricting element, a bolt spanning the distance between the first lug and the second lug, and a nut tightenable on the bolt to draw the first lug and the second lug toward each other, the constricting element being constricted as the lugs are drawn toward each other. The sealing system is adapted to form a seal over a range of outer conduit dimensions.

In another general aspect, a conduit coupler includes a link member, a circumferential, flexible sealing element, and a constricting element. The link member includes a first portion adapted to span the region between two conduits to be coupled and a second portion coupled to the first portion, the second portion including an inner surface and an outer surface. The circumferential, flexible sealing element is adapted to slidably engage the inner surface of the second portion of the link member. The constricting element surrounds at least a majority of the outer radius of the sealing element and is adapted to slidably engage the sealing element and the outer surface of the second portion of the link member. The constricting element and the inner surface of the second portion of the link member compress the sealing element radially and axially as the constricting element constricts. The constricting element includes at least two section members, each section member coupled to at least one other section member by engagement between a male fitting on one of the coupled members and a female fitting on the other of the coupled members.

In some embodiments, conduit couplers may also include a fastening system coupled to the constricting element, the fastening system operable to constrict and relax the constricting element. In some cases, the fastening system may include: a first lug coupled to a first end of the constricting element; a second lug coupled to a second end of the constricting element; a bolt spanning the distance between the first lug and the second lug; and a nut fixedly attached to the first lug such that the nut is not rotatable; the bolt engaging the nut such that rotation of the bolt draws the first lug and the second lug toward each other, the constricting element being constricted as the lugs are drawn toward each other.

The first portion of the link member may include a cylindrical sleeve; and the second portion of the link member may include an outwardly-flaring, circumferential flange.

The sealing element may include a unitary, polymeric gasket.

The sealing element may include a pressure-assist cavity that opens toward the first portion of the link member.

The section members of the constricting element each may include a curved element with a V-shaped cross-section, a first leg of the curved element slidably engaging the outer surface of the second portion of the link member, a second leg of the curved element slidably engaging the sealing element, the sealing element being axially forced toward the second portion of the link member by the second leg as the constricting element constricts.

The link member, the sealing element, and the constricting element may be adapted to form a seal over a range of conduit outer dimensions. The range is greater than one inch for conduits having a nominal size of six inches.

The constricting element may be adapted to engage a conduit to be coupled to deter axial movement of the conduit coupler.

The at least two section members may include a secondary follower section member disposed between two primary follower section members. In some cases, the secondary follower section member may include a male fitting on one end and a female fitting on an opposite end. In some instances, the secondary follower section member nay be directly coupled to at least one of the two primary follower section members. In some cases, the secondary follower section member may include a first male fitting on one end and a second male fitting on an opposite end. In some cases, the secondary follower section member may include a first female fitting on one end and a second female fitting on an opposite end.

In another general aspect, a conduit coupler includes a link member, a circumferential, flexible sealing element, a constricting element, and a fastening system coupled to the constricting element. The link member includes a first portion adapted to span the region between two conduits to be coupled and a second portion coupled to the first portion, the second portion including an inner surface and an outer surface. The sealing element is adapted to slidably engage the inner surface of the second portion of the link member. The constricting element surrounds at least a majority of the outer radius of the sealing element and is adapted to slidably engage the sealing element and the outer surface of the second portion of the link member. The constricting element and the inner surface of the second portion of the link member compress the sealing element radially and axially as the constricting element constricts. The fastening system is operable to constrict and relax the constricting element. The fastening system includes: a first lug coupled to a first end of the constricting element; a second lug coupled to a second end of the constricting element; a bolt spanning the distance between the first lug and the second lug; and a nut fixedly attached to the first lug such that the nut is not rotatable; the bolt engaging the nut such that rotation of the bolt draws the first lug and the second lug toward each other, the constricting element being constricted as the lugs are drawn toward each other.

In some embodiments, the sealing element includes a pressure-assist cavity that opens toward the first portion of the link member.

In some embodiments, the constricting element includes a curved element with a V-shaped cross-section, a first leg of the curved element slidably engaging the outer surface of the second portion of the link member, a second leg of the curved element slidably engaging the sealing element, and the sealing element being axially forced toward the second portion of the link member by the second leg as the constricting element constricts. In some cases, the constricting element includes at least two section members, each section member coupled to at least one other section member by engagement between a male fitting on one of the coupled members and a female fitting on the other of the coupled members.

In another general aspect, a method for coupling conduits includes: forming a constructing element from at least two section members by attaching each section member to at least one other section member by engagement between a male fitting on one of the coupled members and a female fitting on the other of the coupled members; positioning a sealing system around a first conduit, the sealing system comprising a circumferential, flexible sealing element and the constricting element, the constricting element surrounding at least a majority of the outer radius of the sealing element and adapted to slidably engage the sealing element, the constricting element causing the sealing element to be compressed radially and axially as the constricting element constricts; positioning a link member around the first conduit and a second conduit, the link member comprising a first portion and a second portion, the first portion adapted to span the region between the two conduits, the second portion coupled to the first portion and comprising an inner surface and an outer surface, the inner surface adapted to slidably engage the sealing element and to radially and axially compress the sealing element, the outer surface adapted to slidably engage the constricting element; and constricting the constricting element until the sealing element engages the first conduit.

In some embodiments, the sealing element includes a pressure-assist cavity that opens toward the first portion of the link member.

In some embodiments, the constricting element includes a curved element with a V-shaped cross-section, a first leg of the curved element slidably engaging the outer surface of the second portion of the link member, a second leg of the curved element slidably engaging the sealing element, the sealing element being axially forced toward the second portion of the link member by the second leg as the constricting element constricts.

In some embodiments, constricting the constricting element until the sealing element engages the first conduit includes manipulating a fastening system coupled to the constricting element, the fastening system operable to constrict and relax the constricting element. In some cases, manipulating the fastening system may include: rotating a bolt spanning the distance between a first lug and a second lug, the first lug coupled to a first end of the constricting element and the second lug coupled to a second end of the constricting element; such that engagement between the bolt and a nut fixedly attached to the first lug such that the nut is not rotatable draws the first lug and the second lug toward each other.

In some embodiments, constricting the constricting element until the sealing element engages the first conduit includes constricting the constricting element until the constricting element engages the first conduit.

Various implementations for conduit coupling may have one or more features. For example, as few as one bolt may be used to seal each end of a conduit coupler. As another example, conduit coupling may be achieved over a range of conduit sizes (e.g., pipes of the same nominal size but with different outside diameters or pipes of different nominal sizes). As an additional example, a conduit coupler may be adapted to provide a supplementary pressure-based seal and/or to resist axial movement.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of one example of a conduit coupler.

FIGS. 2 is an axial cross-section of an example conduit coupler.

FIG. 3A-B are enlarged partial cross-sections illustrating the conduit coupler of FIG. 2 in use on conduits of different outer diameters.

FIG. 4 is an enlarged partial cross-section illustrating another implementation of a conduit coupler.

FIG. 5 is a flowchart illustrating an example of a process for conduit coupling.

FIG. 6 is a perspective view of another example conduit coupler.

FIG. 7 is a perspective view of another example conduit coupler.

FIGS. 8A-B are, respectively, a side view and a perspective view of a primary follower section of the conduit coupler of FIG. 7.

FIGS. 9A-B are, respectively, a side view and a perspective view of a secondary follower section of the conduit coupler of FIG. 7.

FIG. 10A-B are enlarged partial cross-sections illustrating the conduit coupler of FIG. 7 in use on conduits of different outer diameters.

Like reference symbols in the various drawings indicate like elements.

### DETAILED DESCRIPTION

Conduit coupling may be used to couple two conduit members end-to-end such that a fluid passageway is provided between the members. In particular implementations, conduit coupling is able to couple pipes of various types and/or diameters.

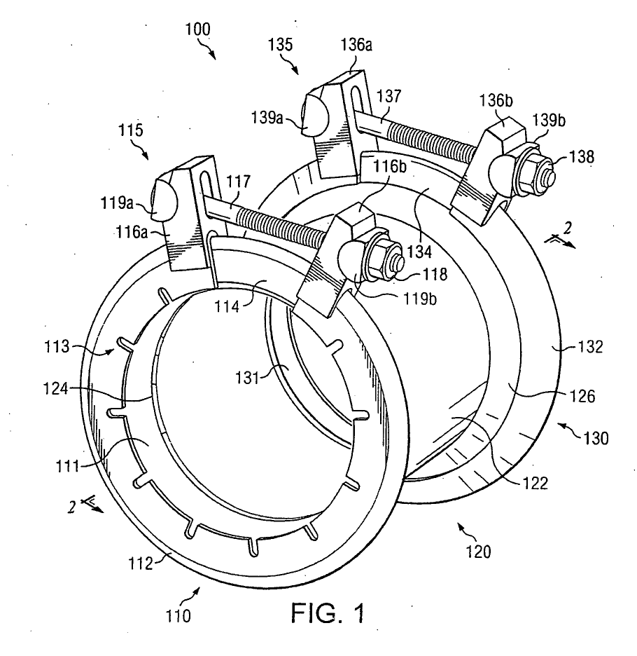

FIG. 1 illustrates one example of a conduit coupler 100. Conduit coupler 100 includes a first sealing system 110, a link member 120, and a second sealing system 130. First sealing system 110 and second sealing system 130 include a flexible sealing element 111 and a flexible sealing element 131, respectively.

To use conduit coupler 100, first sealing system 110 is positioned (e.g., by sliding) around the end of a first conduit (e.g., pipe), and second sealing system 130 is positioned around the end of a second conduit, the first and second conduits not necessarily having the same dimensions (e.g., outer diameters). Link member 120, in turn, is positioned around the region between the ends of the two conduits. If the two conduits abut, the region may be quite small. First sealing system 110 and second sealing system 130 may then constrict. In doing so, first sealing system 110 and second sealing system 130 respectively compress flexible sealing element 111 and flexible sealing element 131 axially towards link member 120 and radially inward toward the respective conduits until the sealing elements at least make contact with the conduits.

In more detail, first sealing system 110 also includes a constricting element (e.g., a follower) 112, a spanner 114, and a fastening system 115. Constricting element 112 is operable to compress sealing element 111 to seal one end of conduit coupler 100 to a conduit to be coupled. Constricting element 112 has a generally concave cross-section, which, in certain implementations, is V-shaped. Also in this implementation, constricting element 112 has radially-disposed slots 113. Slots 113 facilitate the constriction of constricting element 112, especially when constricting element 112 may have a large range of motion. In other implementations, constricting element 112 may not have slots 113.

Constricting element 112 generally surrounds the radial periphery of sealing element 111 and compresses it when constricted by fastening system 115. In this implementation, however, constricting element 112 does not surround the entire radial periphery of sealing element 111. Spanner 114 bridges the gap where constricting element 112 does not engage sealing element 111. When constricted by fastening system 115, constricting element 112 squeezes spanner 114. Spanner 114, in turn, compresses a portion of sealing element 111.

In the present implementation, sealing element 111 is a unitary-polymeric gasket. However, sealing element 111 may be composed of one or more layers of the same or different materials. Additionally, the sealing element may have random fibers or spun web embedded in the sealing element. Metal, polymeric materials, elastomers, asbestos, and other materials also may be used to construct the sealing element. The materials may be well known in the art or heretofore not yet developed. In general, the sealing element may be composed of any appropriate material and have any configuration that will function to substantially prevent the passage of gas, liquid, or particulate matter (any one or any combination thereof) from a pressurized environment to an unpressurized or lower-pressurized environment. In certain implementations, sealing element 111 may include a cavity to capture pressure and assist in sealing the conduit coupler.

Fastening system 115 includes lugs 116, each of which is coupled (e.g., by welding) to a different end of constricting element 112. Fastening system 115 also includes bolt 117 and nut 118, which allow lugs 116 to be moved toward or away from each other, the fastening system constricting constricting element 112 when lugs 115 move toward each other. Fastening system 115 additionally includes bearings 119, which assist in aligning bolt 117 and nut 118.

Similar to first sealing system 110, second sealing system 130 includes a constricting element 132, a spanner 134, and a fastening system 135. Constricting element 132 has a generally concave cross-section, which, in certain implementations, is V-shaped, and includes slots (not visible), to facilitate the constriction of constricting element 132. In general, constricting element 132 surrounds the radial periphery of sealing element 131 and compresses it when constricted by fastening system 135. Spanner 134 bridges the gap where constricting element 132 does not engage sealing element 131. When fastening system 135 constricts, constricting element 132 squeezes spanner 134. Spanner 134, in turn, compresses sealing element 131.

Fastening system 135 includes lugs 136, each of which is coupled to a different end of constricting element 132. Fastening system 135 also includes a bolt 137 and a nut 138, which allow lugs 136 to be moved toward or away from each other, the fastening system constricting constricting element 132 when lugs 135 move toward each other. Fastening system 135 additionally includes bearings 139, which assist in aligning bolt 137 and nut 138.

Link member 120 includes a sleeve portion 122, an outwardly flaring end portion 124 (e.g., a flange), and an outwardly flaring end portion 126. Sleeve portion 122 is designed to fit over conduits of various outside diameters, and end portion 124 and end portion 126 interact with constricting element 112 and constricting element 132, respectively, to assist in sealing the conduits being coupled.

In one mode of operation, first fastening system 110 is slid over a first conduit, second fastening system 130 is slid over a second conduit, and link member 120 is aligned so that it spans the region between the two conduits. Then, nut 119 and nut 139 are tightened to a predetermined torque. As nut 119 and nut 139 tighten, constricting element 112 and constricting element 132, respectively, compress sealing element 111 and sealing element 131 axially towards link member 120 and radially inward, at least until the sealing elements make contact with the conduits.

System 100 has a variety of features. For example, as few as one bolt may be used to seal each end of the coupler. This may provide for ready conduit coupling in what are not uncommonly space-constrained and/or harsh working conditions. As another example, due to the radial and axial movement of the constricting element, the conduit coupler may be used over a range of conduit sizes (e.g., pipes of the same nominal size but with different outside diameters or pipes of different nominal sizes). Also, slots in the constricting elements facilitate the constriction of the constricting rings.

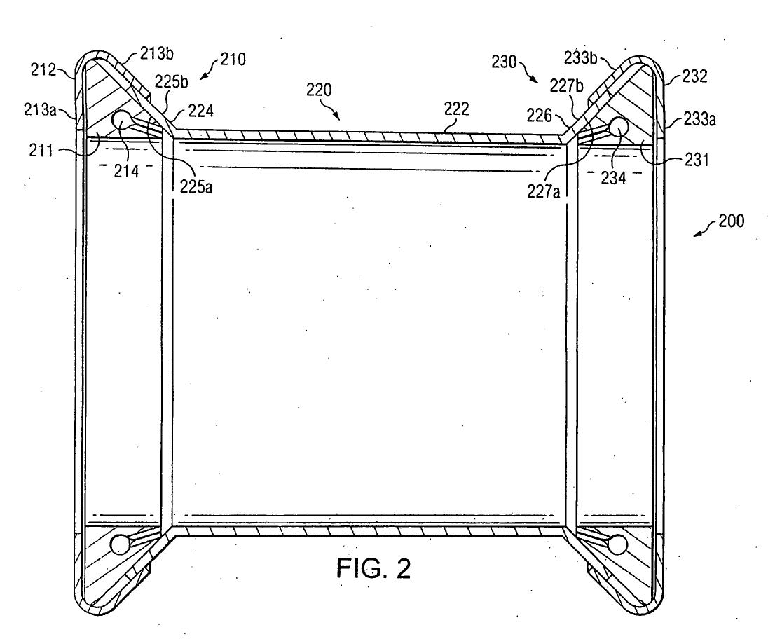

FIG. 2 illustrates an implementation of a conduit coupler 200, which may be similar to conduit coupler 100. Conduit coupler 200 includes a first sealing system 210, a link member 220, and a second sealing system 230. First sealing system 210 and second sealing system 230 operate in conjunction with link member 220 to couple two conduits together.

In more detail, first sealing system 210 includes a flexible sealing element 211 and a constricting element 212, which is operable to compress sealing element 211 to seal one end of conduit coupler 200 to a conduit to be coupled. Constricting element 212 has a V-shaped cross-section that includes a first leg 213a and a second leg 213b, which at least partially surround sealing element 211 radially and compress it when constricting element 212 constricts. Sealing element 211 includes a pressure-assist cavity 214. Pressure-assist cavity 214 opens toward link member 220. Thus, if fluid (e.g., gas or liquid) escapes the conduits being coupled, it may first enter cavity 214 and expand sealing element 211, thereby providing an improved seal.

Similar to first sealing system 210, second sealing system 230 includes a flexible sealing element 231 and a constricting element 232 that is operable to compress sealing element 231 to seal one end of conduit coupler 200 to a conduit to be coupled. Constricting element 232 has a V-shaped cross-section that includes a first leg 233a and a second leg 233b, which at least partially surround sealing element 231 radially and compress it when constricting element 232 constricts. Sealing element 231 includes a pressure-assist cavity 234. Pressure-assist cavity 234 opens toward link member 220. Thus, if fluid escapes the conduits being coupled, it may first enter cavity 234 and expand sealing element 231, thereby providing an improved seal.

Link member 220 includes a sleeve portion 222, an outwardly-flaring end portion 224, and an outwardly-flaring end portion 226. Sleeve portion 222 is designed to fit over conduits of various outside diameters, and end portion 224 and end portion 226 interact with constricting element 212 and constricting element 232, respectively, to assist in sealing the conduits being coupled. End portion 224 includes an inner surface 225a and an outer surface 225b. End portion 226 includes an inner surface 227a and an outer surface 227b.

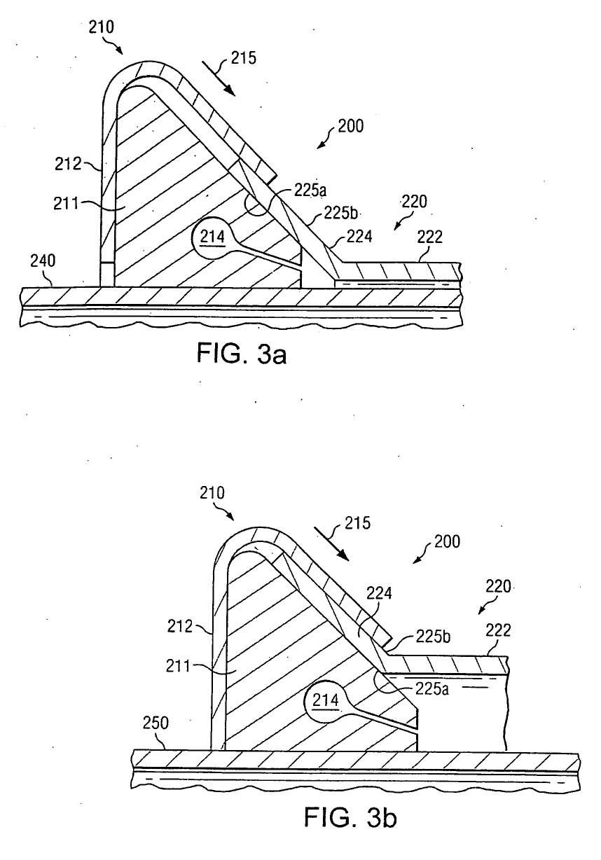

FIGS. 3A-B illustrate conduit coupler 200 in use on conduits of different outer diameters. Conduit coupler 200 can typically be used over a range of conduit outer diameters.

In FIG. 3A, conduit coupler 200 is being used on a conduit 240 that is at or near the maximum outer diameter for conduit coupler 200. During installation, sealing system 210 is positioned around conduit 240, and link member 220 is positioned to span the region between conduit 240 and the other conduit to be coupled. Constricting member 212 then constricts. During constriction, constricting element 212 moves in the direction of arrow 215. In so moving, constricting element 212 may at first move sealing element 211 axially and/or radially until it engages inner surface 225a of end portion 224 and conduit 240 and then compress sealing element 211 axially and radially. During movement of sealing element 211, the sealing element may slide relative to end portion 224, constricting element 212, and/or conduit 240. Constricting element 212 itself slides along outer surface 225b of end portion 224. In the radial direction, sealing element 211 is compressed between inner surface 225a of end portion 224 and conduit 240. In the axial direction, sealing element 211 is compressed between constricting element 212 and inner surface 225a. Sealing system 210 may have achieved an acceptable seal as shown in FIG. 3A. However, in certain modes of operation, constricting element 212 will continue to constrict until engaging conduit 240. This engagement may restrict the ability of sealing system 210, and, hence, conduit coupler 240, to move axially relative to conduit 240.

During one mode of operation, fluid may escape from the conduit interface region into the area between sleeve portion 222 and conduit 240. The fluid may be captured in pressure-assist cavity 214, which opens toward sleeve portion 222. Upon capturing sufficient fluid, pressure-assist cavity 214 expands and further compresses sealing element 211, providing an enhanced seal.

In FIG. 3B, conduit coupler 200 is being used on a conduit 250 that is at or near the minimum outer diameter for conduit coupler 200. During installation, sealing system 210 is positioned around conduit 250, and link member 220 is positioned to span the region between conduit 250 and the other conduit to be coupled. Constricting member 212 then constricts. During constriction, constricting element 212 moves in the direction of arrow 215. In so moving, constricting element 212 may at first move sealing element 211 axially and/or radially until it engages inner surface 225a of end portion 224 and conduit 250 and then compress sealing element 211 axially and radially. During movement of sealing element 211, the sealing element may slide relative to end portion 224, constricting element 212, and/or conduit 250. Constricting element 212 itself slides along outer surface 225b of end portion 224. The inner diameter of sealing element 211 is reduced until it engages the outer surface of the conduit to be coupled. In the radial direction, sealing element 211 is compressed between inner surface 225a of end portion 224 and conduit 250. In the axial direction, sealing element 211 is compressed between constricting element 212 and inner surface 225a.

Sealing system 210 has been sealed to conduit 250 as shown in FIG. 3B by engaging constricting element 212 with conduit 250. The engagement of constricting element 212 with conduit 250 may restrict the ability of sealing system 210 to move axially relative to conduit 250. However, in certain modes of operation, constricting element 212 does not have to constrict to the point at which it engages conduit 250.

During one mode of operation, fluid may escape from the conduit into the region between sleeve portion 222 and conduit 250. The fluid may be captured in pressure-assist cavity 214, which opens toward sleeve portion 222. Upon capturing sufficient fluid, pressure-assist cavity 214 expands and further compresses sealing element 211, providing an enhanced seal.

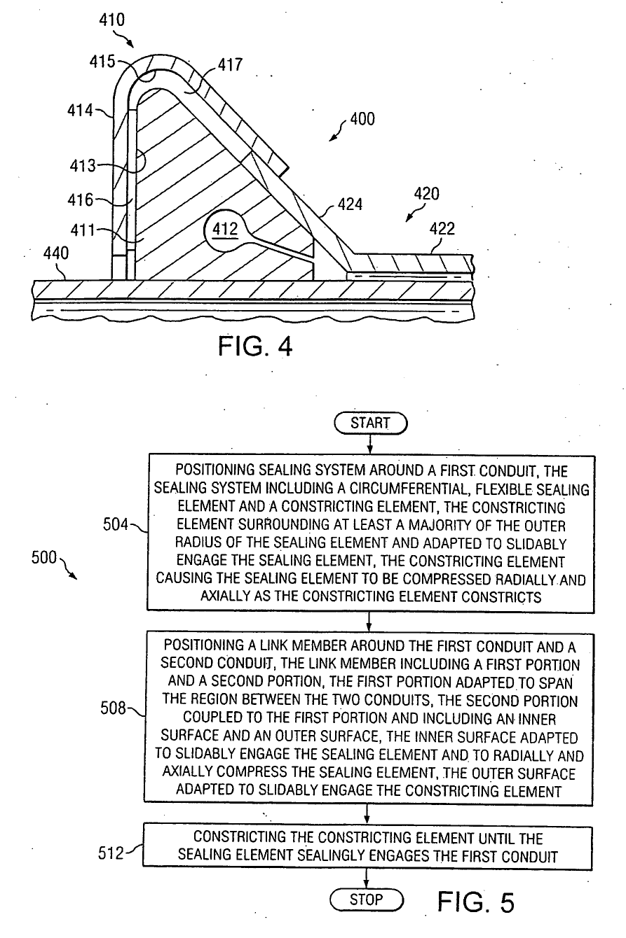

FIG. 4 illustrates a conduit coupler 400. Conduit coupler 400 includes a sealing system 410 and a link member 420. Sealing system 410 includes a flexible sealing element 411 and a constricting element 414, which is operable to compress sealing element 411 to seal one end of conduit coupler 400 to a conduit 440 to be coupled. Constricting element 414 includes an inner surface 415, and link member 420 includes a sleeve member 422 and an end portion 424. Inner surface 415 defines an outer boundary for a cavity 417 for the sealing element.

Sealing element 411 includes a pressure-assist cavity 412 and an outer surface 413. Pressure-assist cavity 412 opens toward sleeve member 422. Thus, if pressure escapes the conduits being coupled, it may travel between conduit 440 and sleeve member 422 and enter cavity 412. Once a sufficient amount of pressure has entered cavity 412, cavity 412 expands and, hence, further compresses sealing element 411, thereby providing an improved seal.

Sealing system 410 also includes a spacer element 416 disposed between sealing element 411 and constricting element 414. Spacer element 416 may have a ring-type configuration that has generally flat first and second sides. In certain implementations, spacer element 416 may be contoured to follow outer surface 413 of sealing element 411 and/or to follow inner surface 415 of constricting element 414. In particular implementations, spacer element 416 may extend around inner surface 415 of constricting element 414 toward end portion 424. One or more surfaces of spacer element 416 may include a friction-reducing material such as TEFLON™, a petroleum-based lubricant, a silicone-based lubricant, graphite, or any other appropriate friction-reducing coating, whether known or yet to be discovered. The friction-reducing material may be embedded in the surface, coated on the surface, or otherwise part of the surface.

Spacer element 416 provides the ability for conduit coupler 400 to be used on conduits slightly larger than those for which the sealing system was designed. Also, spacer element 416 may be used to augment a slightly undersized sealing element or one that has been damaged or worn.

FIG. 5 illustrates one example of a process 500 for conduit coupling. Process 500 may, for example, illustrate a process for installing system 100.

Process 500 calls for positioning a sealing system around a first conduit, the sealing system including a circumferential, flexible sealing element and a constricting element, the constricting element surrounding at least a majority of the outer radius of the sealing element and adapted to slidably engage the sealing element, the constricting element causing the sealing element to be compressed radially and axially as the constricting element constricts (operation 504).

Process 500 also includes positioning a link member around the first conduit and a second conduit, the link member including a first portion and a second portion, the first portion adapted to span the region between the two conduits, the second portion coupled to the first portion and including an inner surface and an outer surface, the inner surface adapted to slidably engage the sealing element and to radially and axially compress the sealing element, the outer surface adapted to slidably engage the constricting element (operation 508).

The process additionally includes constricting the constricting element until the sealing element sealingly engages the first conduit (operation 512).

Although process 500 illustrates one example of a process for conduit coupling, other processes may include fewer, additional, and/or a different arrangement of operations. For example, a process may call for sliding the link member over the second conduit before sliding the sealing system over the first conduit. As another example, a process may call for sliding a sealing system over the second conduit and sealingly engaging that sealing system with the second conduit. As a further example, a process may include manipulating a fastening system coupled to the constricting element to constrict the constricting element. As an additional example, a process may call for constricting the constricting element until the constricting element engages the first conduit. This may assist in preventing axial movement of the sealing system relative to the first conduit.

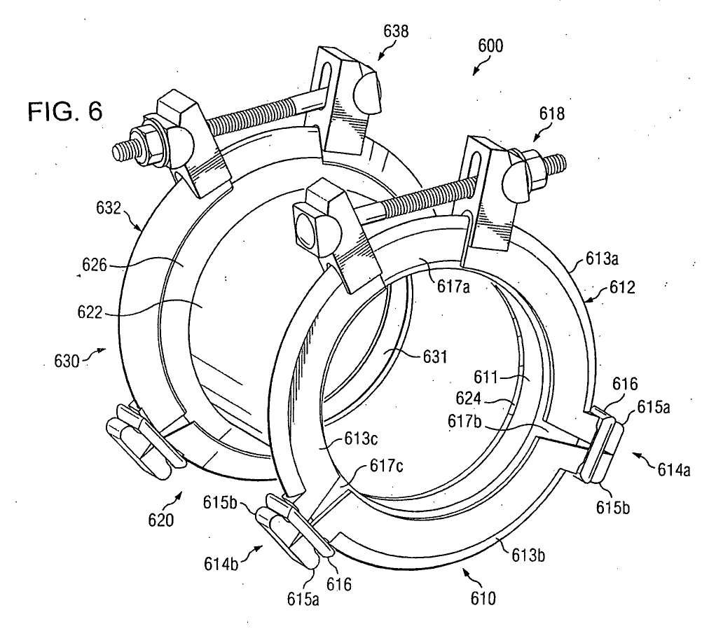

FIG. 6 illustrates one example of a conduit coupler 600. Conduit coupler 600 includes a first sealing system 610, a link member 620, and a second sealing system 630. First sealing system 610 and second sealing system 630 include a flexible sealing element 611 and a flexible sealing element 631, respectively.

To use conduit coupler 600, first sealing system 610 is positioned around the end of a first conduit, and second sealing system 630 is positioned around the end of a second conduit, the first and second conduits not necessarily having the same dimensions. Link member 620, in turn, is positioned around the region between the ends of the two conduits. First sealing system 610 and second sealing system 630 may then constrict. In doing so, first sealing system 610 and second sealing system 630 respectively compress flexible sealing element 611 and flexible sealing element 631 axially towards link member 620 and radially inward toward the respective conduits until the sealing elements at least make contact with the conduits.

In more detail, first sealing system 610 also includes a constricting element 612, spanners 617, and a fastening system 618. Constricting element 612 is operable to compress sealing element 611 to seal one end of conduit coupler 600 to a conduit to be coupled. Constricting element 612 includes sections 613 and coupling systems 614. Sections 613 have a generally concave cross-section, which, in certain implementations, is V-shaped. Sections 613 facilitate the constriction of constricting element 612, especially when constricting element 612 may have a large range of motion. Coupling systems 614 couple sections 613 together and include coupling adapters 615 (e.g., ears) coupled to sections 613. To couple coupling adapters 615 together, each of coupling adapters 615 includes a groove, and coupling systems 614 also include couplers 616 (e.g., links) that fit into the grooves. Coupling adapters 615 and couplers 616 allow sections 613 to be movably coupled to each other. In particular, neighboring sections 613 may move hingedly relative to each other. When constricting element 612 is constricted by fastening system 618, couplers 616 are placed into tension.

Constricting element 612 generally surrounds the radial periphery of sealing element 611 and compresses it when constricted by fastening system 618. In this implementation, however, constricting element 612 does not surround the entire radial periphery of sealing element 611. Spanners 617 bridge the gaps where constricting element 612 does not engage sealing element 611. When constricted by fastening system 618, constricting element 612 squeezes spanners 617. Spanners 617, in turn, compress their respective portions of sealing element 611.

Sealing element 611 may be a unitary-polymeric gasket or any other appropriate configuration and/or material that will function to substantially prevent the passage of gas, liquid, or particulate matter (any one or any combination thereof) from a pressurized environment to an unpressurized or lower-pressurized environment. In certain implementations, sealing element 611 may include a cavity to capture pressure and assist in sealing the conduit coupler.

Second sealing system 630 is generally similar to first sealing system 610. As mentioned previously, sealing system 630 includes sealing element 631. Sealing system 630 also includes a constricting element 632 and a fastening system 638. Constricting element 632 has a generally concave cross-section, which, in certain implementations, is V-shaped, and generally surrounds the radial periphery of sealing element 631 and compresses it when constricted by fastening system 638.

Link member 620 includes a sleeve portion 622, an outwardly flaring end portion 624, and an outwardly flaring end portion 626. Sleeve portion 622 is designed to fit over conduits of various outside diameters, and end portion 624 and end portion 626 interact with constricting element 612 and constricting element 632, respectively, to assist in sealing the conduits being coupled.

In one mode of operation, first fastening system 610 is slid over a first conduit, second fastening system 630 is slid over a second conduit, and link member 620 is aligned so that it spans the region between the two conduits. Then, fastening system 618 and fastening system 638 are tightened, which constricts constricting element 612 and constricting element 632, respectively, compressing sealing element 611 and sealing element 631 axially towards link member 620 and radially inward. The sealing elements may be constricted until they at least make contact with the conduits.

Although FIG. 6 illustrates one implementation of a conduit coupler, other implementations may have fewer, additional, and/or a different arrangement of components. For example, a constricting element may have two or more sections. As another example, the coupling systems may be pin-type joints, or the sections may have interlocking geometries that form the coupling systems. The coupling mechanisms may allow neighboring sections to move hingedly relative to each other.

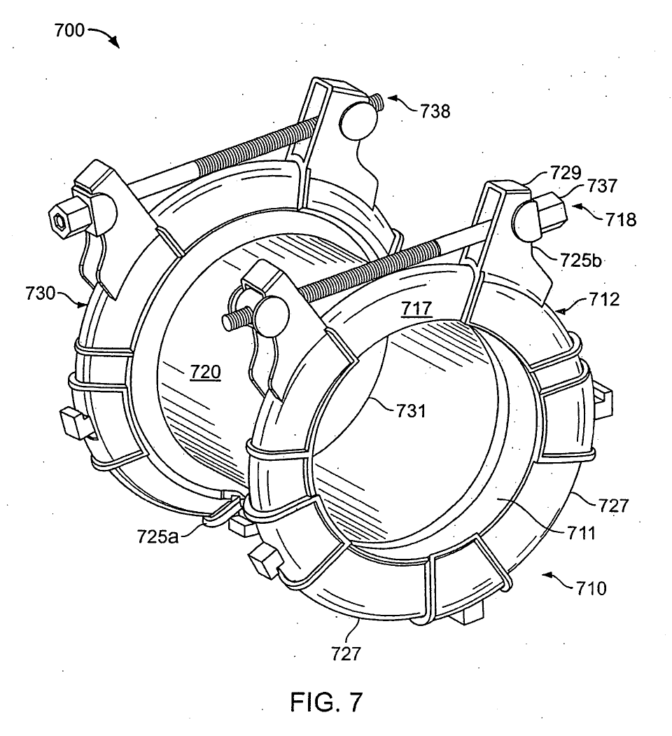

FIG. 7 illustrates another example of a conduit coupler 700. Conduit coupler 700 includes a first sealing system 710, a link member 720, and a second sealing system 730. First sealing system 710 and second sealing system 730 include a flexible sealing element 711 and a flexible sealing element 731, respectively.

To use conduit coupler 700, first sealing system 710 is positioned around the end of a first conduit, and second sealing system 730 is positioned around the end of a second conduit, the first and second conduits not necessarily having the same dimensions. Link member 720, in turn, is positioned around the region between the ends of the two conduits. First sealing system 710 and second sealing system 730 may then constrict. In doing so, first sealing system 710 and second sealing system 730 respectively compress flexible sealing element 711 and flexible sealing element 731 axially towards link member 720 and radially inward toward the respective conduits until the sealing elements at least make contact with the conduits.

In more detail, first sealing system 710 also includes a constricting element 712, a spanner 717, and a fastening system 718. Constricting element 712 is operable to compress sealing element 711 to seal one end of conduit coupler 700 to a conduit to be coupled. Constricting element 712 includes primary follower sections 725a, 725b and secondary follower sections 727. Primary and secondary follower sections 725a, 725b, 727 are configured for interlocking engagement with each other as will be described in more detail below. Primary follower sections 725 a, 725b include flanges 729 configured to receive fastening system 718. Follower sections 725 a, 725b, 727 facilitate the constriction of constricting element 712, especially when constricting element 712 may have a large range of motion. The illustrated embodiment includes two primary follower sections 725 a, 725b and two secondary follower sections 727. However, other embodiments can include other numbers (e.g., zero, one, three, or more) of secondary follower sections 727.

In some embodiments, fastening system 718 includes threaded bolt 733 which extends through flanges 729 and engages nut 735. Nut 735 and flange 729 are configured such that engagement between the nut and the flange can prevent rotation of the nut. Thus, fastening system 718 is tightened or loosened by using an appropriate tool (e.g., a socket) to engage a head 737 of bolt 733 to rotate the bolt. This approach can provide increased ease of operation (e.g., more flexibility in the choice of tools) relative to fastening systems (e.g., fastening system 618 shown in FIG. 6) in which the head of the bolt locks into engagement with the flange and nut rotates because the tool used does not have to accommodate the bolt extending through the nut.

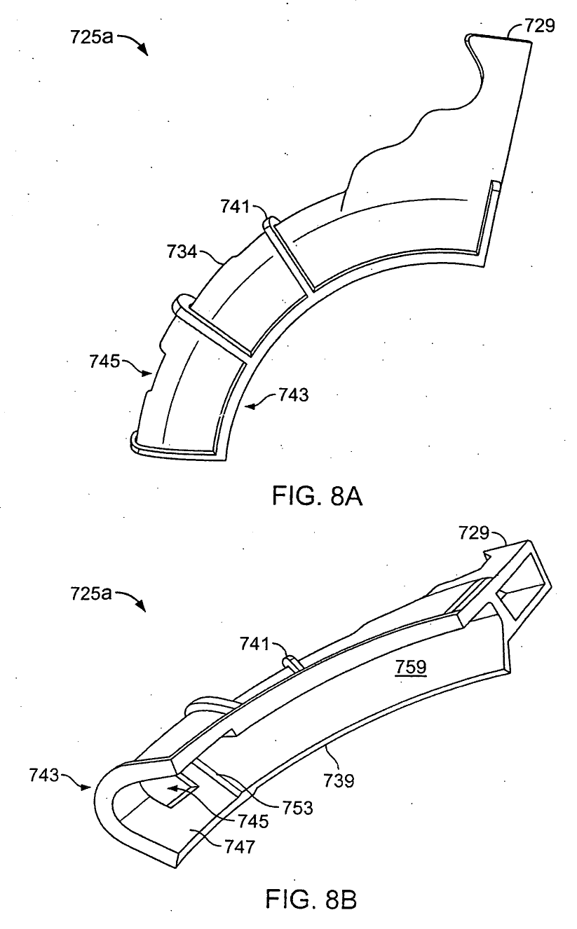

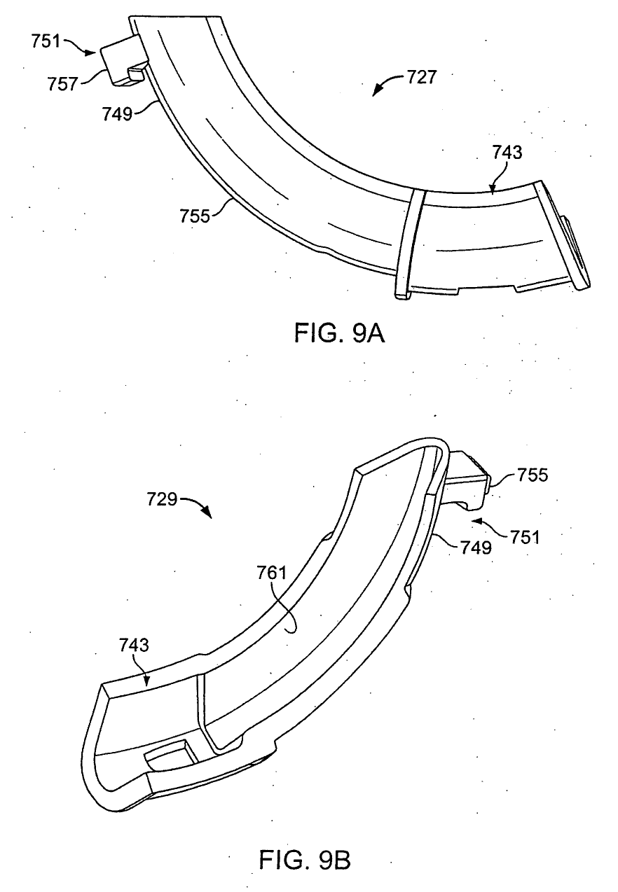

Referring to FIGS. 8A and 8B, primary follower section 725a includes flange 729 extending from a sleeve 739. Sleeve 739 can have a generally concave cross-section, which, in certain implementations, is V-shaped. Sleeve 739 can include a rib or ribs 741 whose presence increases the ease of forming the sleeve by facilitating the casting process. In some instances, ribs 741 can also provide additional structural strength and stability to the sleeve. Primary follower section 725a includes a female receiving section 743. Female receiving section 743 has an aperture 745 extending through the female receiving section. An inner surface 747 of the female receiving section 743 is sized and configured to receive and slidingly engage the outer surface 749 of a corresponding male engaging section 751 of an interlocking follower section (e.g., secondary follower section 727—see FIGS. 9A and 9B). A shoulder 753 can be formed at the transition between female receiving section 743 and the remainder of sleeve 739. Shoulder 753 can be arranged to limit the discontinuity relative to the gasket at the transition between adjacent sections. Primary follower section 725b (see FIG. 7) is configured in a substantially similar fashion to primary follower section 725a. However, in place of female receiving section 743, primary follower section 725b includes a male engaging section similar to those described in more detail below with reference to secondary follower sections 727.

Referring also to FIGS. 9A and 9B, secondary follower sections 727 are similar to primary follower sections 725a, 725b in including a sleeve 755. However, in this embodiment, secondary follower sections 727 include a male engaging section 751 and a female receiving section 743 rather than including a flange 729 and a female receiving section 743 or a male engaging section 751 as found on primary follower sections 725a, 725b. Male engaging section 751 includes an outer surface 749 sized and configured to be received in and slidingly engage the inner surface 749 of a corresponding female receiving section 743 of an interlocking follower section (e.g., primary follower section 725a). Male engaging section 751 also includes a projection 757 extending radially outward from sleeve 755. Projection 757 is sized and configured to extend through aperture 745 of a corresponding female receiving section 743. In addition, sleeves 739 of primary follower sections 725a, 725b and sleeves 755 of secondary follower sections 727 have inner surfaces 759, 761 that are sized and configured to match to provide smooth transitions between follower sections when the follower sections are assembled together.

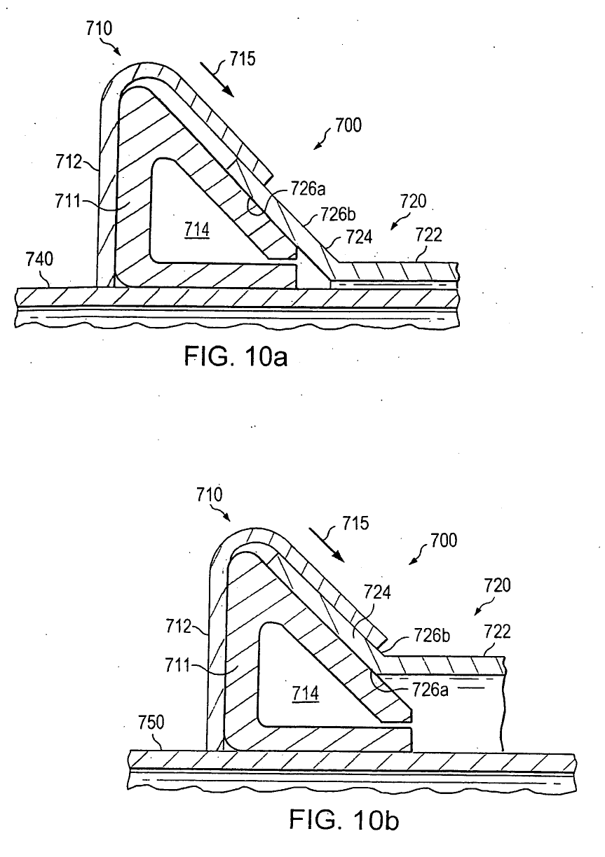

FIGS. 10A-B illustrate conduit coupler 700 in use on conduits of different outer diameters. Conduit coupler 700 can typically be used over a range of conduit outer diameters.

In FIG. 10A, conduit coupler 700 is being used on a conduit 740 that is at or near the maximum outer diameter for conduit coupler 700. During installation, sealing system 710 is positioned around conduit 740, and link member 720 is positioned to span the region between conduit 740 and the other conduit to be coupled. Constricting member 712 then constricts. During constriction, constricting element 712 moves in the direction of arrow 715. In so moving, constricting element 712 may at first move sealing element 711 axially and/or radially until it engages inner surface 726a of end portion 724 of link member 720 and conduit 740 and then compress sealing element 711 axially and radially. During movement of sealing element 711, the sealing element may slide relative to end portion 724, constricting element 712, and/or conduit 740. Constricting element 712 itself slides along outer surface 726b of end portion 724. In the radial direction, sealing element 711 is compressed between inner surface 726a of end portion 724 and conduit 740. In the axial direction, sealing element 711 is compressed between constricting element 712 and inner surface 726a. Sealing system 710 may have achieved an acceptable seal as shown in FIG. 10A. However, in certain modes of operation, constricting element 712 will continue to constrict until engaging conduit 740. This engagement may restrict the ability of sealing system 710, and, hence, conduit coupler 740, to move axially relative to conduit 740.

During one mode of operation, fluid may escape from the conduit interface region into the area between sleeve portion 722 and conduit 740. The fluid may be captured in pressure-assist cavity 714, which opens toward sleeve portion 722. Upon capturing sufficient fluid, pressure-assist cavity 714 expands and further compresses sealing element 711, providing an enhanced seal. Increasing the size of pressure-assist cavity 714 and/or providing the pressure-assist cavity with inner surfaces that are generally parallel to the outer surfaces of sealing element 711 may increase the response of the sealing element fluid captured by the pressure-assist cavity.

In FIG. 10B, conduit coupler 700 is being used on a conduit 750 that is at or near the minimum outer diameter for conduit coupler 700. During installation, sealing system 710 is positioned around conduit 750, and link member 720 is positioned to span the region between conduit 750 and the other conduit to be coupled. Constricting member 712 then constricts. During constriction, constricting element 712 moves in the direction of arrow 715. In so moving, constricting element 712 may at first move sealing element 711 axially and/or radially until it engages inner surface 726a of end portion 724 and conduit 750 and then compress sealing element 711 axially and radially. During movement of sealing element 711, the sealing element may slide relative to end portion 724, constricting element 712, and/or conduit 750. Constricting element 712 itself slides along outer surface 726b of end portion 724. The inner diameter of sealing element 711 is reduced until it engages the outer surface of the conduit to be coupled. In the radial direction, sealing element 711 is compressed between inner surface 726a of end portion 724 and conduit 750. In the axial direction, sealing element 711 is compressed between constricting element 712 and inner surface 726a.

Sealing system 710 has been sealed to conduit 750 as shown in FIG. 10B by engaging constricting element 712 with conduit 750. The engagement of constricting element 712 with conduit 750 may restrict the ability of sealing system 710 to move axially relative to conduit 750. However, in certain modes of operation, constricting element 712 does not have to constrict to the point at which it engages conduit 750.

During one mode of operation, fluid may escape from the conduit into the region between sleeve portion 722 and conduit 750. The fluid may be captured in pressure-assist cavity 714, which opens toward sleeve portion 722. Upon capturing sufficient fluid, pressure-assist cavity 714 expands and further compresses sealing element 711, providing an enhanced seal.

Referring again to FIG. 7, sealing element 711 may be a unitary-polymeric gasket or any other appropriate configuration and/or material that will function to substantially prevent the passage of gas, liquid, or particulate matter (any one or any combination thereof) from a pressurized environment to an unpressurized or lower-pressurized environment. In certain implementations, sealing element 711 may include a cavity to capture pressure and assist in sealing the conduit coupler.

Second sealing system 730 is generally similar to first sealing system 710. As mentioned previously, sealing system 730 includes sealing element 731. Sealing system 730 also includes a constricting element 732 and a fastening system 738. Constricting element 732 has a generally concave cross-section, which, in certain implementations, is V-shaped, and generally surrounds the radial periphery of sealing element 731 and compresses it when constricted by fastening system 738.

In one mode of operation, first fastening system 710 is slid over a first conduit, second fastening system 730 is slid over a second conduit, and link member 720 is aligned so that it spans the region between the two conduits. Then, fastening system 718 and fastening system 738 are tightened, which constricts constricting element 712 and constricting element 732, respectively, compressing sealing element 711 and sealing element 731 axially towards link member 720 and radially inward. The sealing elements may be constricted until they at least make contact with the conduits.

Although FIG. 7 illustrates one implementation of a conduit coupler, other implementations may have fewer, additional, and/or a different arrangement of components. For example, a constricting element may have three or more secondary follower sections.

A number of implementations have been described, and several others have been mentioned or suggested. Moreover, various additions, deletions, substitutions, and/or modifications to these implementations may be readily suggested to those skilled in the art while still achieving conduit coupling.

For example, in some embodiments, conduit couplers can include a secondary follower section with two male engaging sections (e.g., male engaging sections on both ends of the secondary follower section) rather than having a male engaging section on one end and a female receiving section on the other end. A dual-male secondary follower section can be directly coupled with two primary follower sections that both have female engaging sections. Alternatively, additional secondary follower sections can be included (e.g., disposed between the dual-male secondary follower and one or both of the primary follower sections). Similarly, conduit couplers can include a secondary follower section with two female receiving sections.

Accordingly, other embodiments are within the scope of the following claims.

What is claimed is:

1. A conduit coupler comprising:
a link member comprising a first portion and a second portion, the first portion adapted to span the region between two conduits to be coupled, the second portion coupled to the first portion and comprising an inner surface and an outer surface;
a circumferential, flexible sealing element, the sealing element adapted to slidably engage the inner surface of the second portion of the link member; and
a constricting element surrounding at least a majority of the outer radius of the sealing element and adapted to slidably engage the sealing element and the outer surface of the second portion of the link member, the constricting element and the inner surface of the second portion of the link member compressing the sealing element radially and axially as the constricting element constricts;
wherein the constricting element comprises at least two section members, each section member coupled to at least one other section member by engagement between a male fitting on one of the coupled members and a female fitting on the other of the coupled members.

2. The conduit coupler of claim 1, further comprising a fastening system coupled to the constricting element, the fastening system operable to constrict and relax the constricting element.

3. The conduit coupler of claim 2, wherein the fastening system comprises:
a first lug coupled to a first end of the constricting element;
a second lug coupled to a second end of the constricting element;
a bolt spanning the distance between the first lug and the second lug; and
a nut fixedly attached to the first lug such that the nut is not rotatable;
the bolt engaging the nut such that rotation of the bolt draws the first lug and the second lug toward each other, the constricting element being constricted as the lugs are drawn toward each other.

4. The conduit coupler of claim 1, wherein:
the first portion of the link member comprises a cylindrical sleeve; and
the second portion of the link member comprises an outwardly-flaring, circumferential flange.

5. The conduit coupler of claim 1, wherein the sealing element comprises a unitary, polymeric gasket.

6. The conduit coupler of claim 1, wherein the sealing element comprises a pressure-assist cavity that opens toward the first portion of the link member.

7. The conduit coupler of claim 1, wherein the section members of the constricting element each comprise a curved element with a V-shaped cross-section, a first leg of the curved element slidably engaging the outer surface of the second portion of the link member, a second leg of the curved element slidably engaging the sealing element, the sealing element being axially forced toward the second portion of the link member by the second leg as the constricting element constricts.

8. The conduit coupler of claim 1, wherein the link member, the sealing element, and the constricting element are adapted to form a seal over a range of conduit outer dimensions.

9. The conduit coupler of claim 8, wherein the range is greater than one inch for conduits having a nominal size of six inches.

10. The conduit coupler of claim 1, wherein the constricting element is adapted to engage a conduit to be coupled to deter axial movement of the conduit coupler.

11. The conduit coupler of claim 1, wherein the at least two section members include a secondary follower section member disposed between two primary follower section members.

12. The conduit coupler of claim 11, wherein the secondary follower section member comprises a male fitting on one end and a female fitting on an opposite end.

13. The conduit coupler of claim 12, wherein the secondary follower section member is directly coupled to at least one of the two primary follower section members.

14. The conduit coupler of claim 11, wherein the secondary follower section member comprises a first male fitting on one end and a second male fitting on an opposite end.

15. The conduit coupler of claim 11, wherein the secondary follower section member comprises a first female fitting on one end and a second female fitting on an opposite end.

16. A conduit coupler comprising:
a link member comprising a first portion and a second portion, the first portion adapted to span the region between two conduits to be coupled, the second portion coupled to the first portion and comprising an inner surface and an outer surface;
a circumferential, flexible sealing element, the sealing element adapted to slidably engage the inner surface of the second portion of the link member;
a constricting element surrounding at least a majority of the outer radius of the sealing element and adapted to slidably engage the sealing element and the outer surface of the second portion of the link member, the constricting element and the inner surface of the second portion of the link member compressing the sealing element radially and axially as the constricting element constricts; and
a fastening system coupled to the constricting element, the fastening system operable to constrict and relax the constricting element, the fastening system comprising:
a first lug coupled to a first end of the constricting element;
a second lug coupled to a second end of the constricting element;
a bolt spanning the distance between the first lug and the second lug; and
a nut fixedly attached to the first lug such that the nut is not rotatable;
the bolt engaging the nut such that rotation of the bolt draws the first lug and the second lug toward each other, the constricting element being constricted as the lugs are drawn toward each other.

17. The conduit coupler of claim 16, wherein the sealing element comprises a pressure-assist cavity that opens toward the first portion of the link member.

18. The conduit coupler of claim 16, wherein the constricting element comprises a curved element with a V-shaped cross-section, a first leg of the curved element slidably engaging the outer surface of the second portion of the link member, a second leg of the curved element slidably engaging the sealing element, the sealing element being axially forced toward the second portion of the link member by the second leg as the constricting element constricts.

19. The conduit coupler of claim 18 wherein the constricting element comprises at least two section members, each section member coupled to at least one other section member by engagement between a male fitting on one of the coupled members and a female fitting on the other of the coupled members.

20. A method for coupling conduits, the method comprising:
forming a constructing element from at least two section members by attaching each section member to at least one other section member by engagement between a male fitting on one of the coupled members and a female fitting on the other of the coupled members;
positioning a sealing system around a first conduit, the sealing system comprising a circumferential, flexible sealing element and the constricting element, the constricting element surrounding at least a majority of the outer radius of the sealing element and adapted to slidably engage the sealing element, the constricting element causing the sealing element to be compressed radially and axially as the constricting element constricts;
positioning a link member around the first conduit and a second conduit, the link member comprising a first portion and a second portion, the first portion adapted to span the region between the two conduits, the second portion coupled to the first portion and comprising an inner surface and an outer surface, the inner surface adapted to slidably engage the sealing element and to radially and axially compress the sealing element, the outer surface adapted to slidably engage the constricting element; and
constricting the constricting element until the sealing element engages the first conduit.

21. The method of claim 20, wherein the sealing element comprises a pressure-assist cavity that opens toward the first portion of the link member.

22. The method of claim 20, wherein the constricting element comprises a curved element with a V-shaped cross-section, a first leg of the curved element slidably engaging the outer surface of the second portion of the link member, a second leg of the curved element slidably engaging the sealing element, the sealing element being axially forced toward the second portion of the link member by the second leg as the constricting element constricts.

23. The method of claim 20, wherein constricting the constricting element until the sealing element engages the first conduit comprises manipulating a fastening system coupled to the constricting element, the fastening system operable to constrict and relax the constricting element.

24. The method of claim 23, wherein manipulating the fastening system comprises:
rotating a bolt spanning the distance between a first lug and a second lug, the first lug coupled to a first end of the constricting element and the second lug coupled to a second end of the constricting element;
such that engagement between the bolt and a nut fixedly attached to the first lug such that the nut is not rotatable draws the first lug and the second lug toward each other.

25. The method of claim 20, wherein constricting the constricting element until the sealing element engages the first conduit comprises constricting the constricting element until the constricting element engages the first conduit.
